(19) United States
(12) Patent Application Publication
(10) Pub. No.: US 2009/0289226 A1
(43) Pub. Date: Nov. 26, 2009

(54) Compound Material for Inorganic Phosphor and White LED

(76) Inventors: Soshchin Naum, Changhua City (TW); Wei-Hung Lo, Taipei City (TW); Chi-Ruei Tsai, Taipei City (TW)

Correspondence Address: The Weintraub Group, P.L.C., 28580 Orchard Lake Road, Suite 140, Farmington Hills, MI, 48334, US

(21) Appl. No.: 12/463,683

(22) Filed: May 11, 2009

(30) Foreign Application Priority Data
May 26, 2008 (TW) 097119324

(51) Int. Cl. C09K 11/02; C09K 11/70

(52) U.S. Cl. 252/301.36

(57) ABSTRACT

A compound material for white LED, including an inorganic phosphor, an inorganic light scatter and a polymer adhesive for interaction with a shortwave light radiated by an InGaN heterostructure. The light scatter is a nano-scale powder material formed of A^{II}B^{VI} quantum dot compound in which A=Zn, Cd; B═O, S, Se, Te, and composed with (Y_{2-x-y-z} GdₓCe_{y}Dy_{z}O₃)_{1.5±α}(Al₂O₃)_{2.5±β} inorganic phosphor to form a compound material.

### BACKGROUND OF THE INVENTION

1. Field of the Invention

The present invention relates to compound materials for LED and inorganic phosphor and more particularly, to a quantum effect-based radiator for used in an InGaN heterostructure semiconductor

2. Description of the Related Art

Some discoveries in physics in the technical field of “Optoelectronics” or “Solid State Light Sources” started in 70's of 20^{th} Century. These discoveries were not employed for useful application at the time they were firstly disclosed or 15 years after their disclosure. A certain time thereafter, Japanese engineer S. Nakamura (please refer to S. Nakamura, G. Fasol “The blue laser diode” Sp˜Verl.B. 1997) discovered and described substantial improvement of InGaN shortwave heterojunction in internal and external quantum outputs.

Thus, high performance blue, violet and ultraviolet LED samples were firstly reacted in 1997. On the same year, Nichia researchers disclosed white LED (see S. Schimisu et. al. U.S. Pat. No. 5,988,925 issued on Dec. 7, 1999), which comprises a blue heterostructure of radiation wavelength λ=455 nm and a coating spectrum conversion layer with yellow radiation phosphor. A part of the first order blue light of the LED is mixed with the yellow light from the spectrum conversion layer, producing white light.

Basically, U.S. Pat. No. 5,988,925 provides no breakthrough solutions. Actually, a GaN-based LED patent was issued in 1977, which has a Stokes phosphor covered thereon (see V. Abramof's USSR patent 1977). This patent describes two types of phosphors, i.e., the Stokes phosphor of which the emission wavelength is greater than the activation wavelength, and the anti-stokes phosphor of which the emission wavelength is shorter than the activation wavelength. In 1977, Russian engineers suggested the use of GaN shortwave activating phosphors. In 1998, Japanese engineers selected the known YAG phosphor for television application (see G Blasse and Luminescent material. Springer Verlag. Berlin 1994). White light comes from two complementary colors, blue and yellow. This theory was discovered by Newton, and widely applied to picture tube screens for black-and-white television and fluorescent lamps.

However, LED market monopoly by Japanese manufacturers imparts a barrier to development of LED illumination technology.

FIG. 1 illustrates the architecture of an InGaN heterostructure-based white LED. As illustrated, the LED architecture 1 comprises an Al₂O₃ based substrate 2, and two electrodes 3 and 4 provided at the substrate 2. The surface area of the heterostructure is 200×300 μm. A spectrum conversion layer is formed on the front and peripheral side. The spectrum conversion layer is formed of a transmissive polymer layer 5 and a phosphor 6 distributed in the transmissive polymer layer 5. The heterostructure carrying the spectrum conversion layer is arranged on a conical reflector. A spherical glass 7 is covered on the focal plane of the heterostructure. The space between the spherical glass 7 and the spectrum conversion layer is filled up with a transmissive polymer (not shown).

When apply voltage about 3.2˜3.4V and current I□20 mA to the two electrodes 3 and 4, the LED emits strong white light. This LED structure is commonly used as a standard for reference (see S. Schimisu et. al's U.S. Pat. No. 5,988,925, issued on Dec. 7, 1999). Despite its wide application, this LED structure still has some drawbacks. At the first place, the front surface and periphery of the semiconductor heterostructure are non-uniform, and therefore they produce different color tones. At the second place, the spectrum conversion layer on the radiation surface of the heterostructure is relatively thinner, about 100 μm, a small fraction of first order blue radiation is seen in the white radiation. A part of the blue radiation directly passes through the spectrum conversion layer without any interaction with the phosphor 6. Under this condition, the spherical glass 7 causes the so-called “hallo effect” in the radiation of the LED device. By means of visual observation, this hallo effect is presented due to that the blue light of the heterostructure is accurately focused onto the facula center and warm white color tone of white radiation is distributed around the facula center. These two phenomena, i.e., color tone (color) different and “halo effect” are the major drawbacks of the known white LED architecture.

Creating a phosphor conversion layer having a uniform concentration is a good way to eliminate the problem of different color tones. At this time, the cover layer on the dominant radiation surface and periphery of the heterostructure has a uniform concentration. To achieve this effect, it can be done by means of enhancing the viscosity of the polymer adhesive of the phosphor conversion layer, or using a special phosphor suspension to automatically quantitatively achieve concentration uniformity (see V. Abramof, N. Soshchin et. al's US 2006006366 patent application, filed on Jan. 12, 2006).

With respect to the way of eliminating “hallo effect”, N. Soshchin et. al's Taiwan Patent 2495678 provides contribution. This patent teaches application of a dispersed light scatter or color dispersant to a phosphor polymer suspension (see N. Soschin, Lo Wei-Hung, P. Tzai et. al's Taiwan Patent 228324 and Eun J. J et. al's US application 20060157681, filed on Jul. 20, 2006). The optical principal is: the first order blue radiation touches dispersed inorganic material particles in its path. These materials commonly use white oxide minerals such as SiO₂, TiO₂, ZnO, and some complicated titanate or nitride compound. Dispersed dispersant powder extends the path of the first order blue light, and causes it to bias. However, it does not let the first order blue light pass, avoiding “hallo effect”.

The aforesaid two ways to eliminate the problem of different color tones and the problem of “hallow effect” are employed to establish a prime model for the present invention.

Despite of intensive use of dispersants, they have some substantial drawbacks: 1. They lower the radiation intensity of the LED; 2. They change the angular distribution of the light outputted through the optical space of the heterostructure; 3. They reduce the luminous efficiency of the LED; and 4. They cause a rise in temperature inside the heterostructure.

### SUMMARY OF THE INVENTION

The present invention has been accomplished under the circumstances in view. It is therefore the main object of the present invention to provide a compound material for LED, which uses dispersed inorganic dispersant powder, eliminating conventional LED optical drawbacks.

It is another object of the present invention to provide a compound material for LED, which has a supplementary composition added to the phosphor conversion layer, lowering first order radiation and total radiation losses.

It is still another object of the present invention to provide a compound material for LED, which corrects the total radiation of the LED, providing a warm color tone.

It is still another object of the present invention to provide a compound material for LED, which improves the luminous intensity of the LED.

To achieve these and other objects of the present invention, the compound material includes at least two inorganic substances, i.e., phosphor and light scatter, and a polymer adhesive. The compound material is used as a spectrum conversion film for interaction with a shortwave light radiated by an InGaN heterostructure. The compound material is characterized in that the light scatter is a nano-scale powder material formed of A^{II}B^{VI} quantum dot compound in which A=Zn, Cd; B═O, S, Se, Te; and composed with (Y_{2-x-y-z} GdₓCe_{y}Dy_{z}O₃)_{1.5±α}(Al₂O₃)_{2.5±β} inorganic phosphor to form a compound material.

### BRIEF DESCRIPTION OF THE DRAWINGS

FIG. 1 is a schematic drawing showing the architecture of a conventional InGaN heterostructure-based white LED.

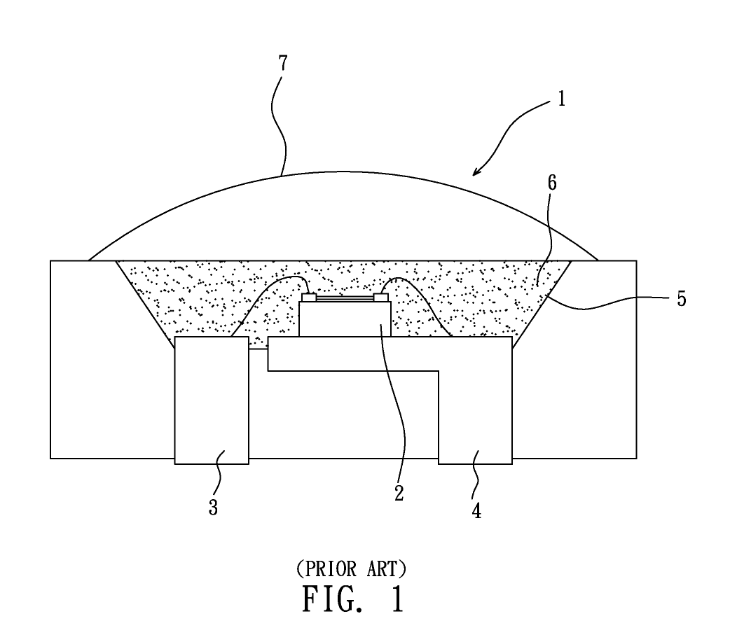

FIG. 2 illustrates the respective spectrum data of the phosphor A and the phosphor A plus quantum dots according to the present invention.

FIG. 3 illustrates the respective spectrum data of the phosphor B and the phosphor B plus quantum dots according to the present invention.

FIG. 4 illustrates the configuration of the phosphor A according to the present invention.

FIG. 5 illustrates the configuration of the phosphor B according to the present invention

### DETAILED DESCRIPTION OF THE PREFERRED EMBODIMENT

A compound material for inorganic phosphor and white LED in accordance with the present invention includes two inorganic substances, i.e., phosphor and light scatter, and a polymer adhesive. The compound material is used as a spectrum conversion film for interaction with a shortwave light radiated by an InGaN heterostructure, characterized in that the light scatter is a nano-scale powder material of A^{II}B^{VI} quantum dot compound in which A=Zn, Cd; B═O, S, Se, Te, and composed with (Y_{2-x-y-z}GdₓCe_{y}Dy_{z}O₃)_{1.5±α}(Al₂O₃)_{2.5±β} inorganic phosphor to form a compound material. When compared to a standard phosphor binding object, the compound material re-radiates the light by a rise about 30˜70%, assuring emission spectrum maximum wavelength λ=542˜544 nm, radiation color coordinates 0.32□x□0.36, 0.32□y□0.38, and dominant wavelength λ□548 nm.

Further, the nano-scale powder material formed of A^{II}B^{VI} quantum dot compound of the light scatter is based on (CdS)_{1˜p}(CdSe)ₚ series, raising Full Wave Half Maximum (FWHM) to λ_{0.5}=130˜132 nm, and simultaneously shifting the radiation toward the long wage region λₘₐₓ=542˜544 nm.

Further, when the spectrum activated by the compound material of the present invention is shifted toward the shortwave region including the ultraviolet portion λ=395˜405 nm, the afterglow duration shortens from τₑ=64 ns to a relatively smaller value.

The compound material of the present invention further comprises an inorganic phosphor-A^{II}B^{VI} quantum dot component that has the mass ratio of 8˜25% and 2˜8% when the concentration of the polymer adhesive in the compound material is 66˜90%.

Further, the refractive index ratio of the components of the compound material of the present invention is:

ηₚₕ:η_{qd}:ηₚₒₗ=1.85:2.0:1.55˜1.90:2.4:1.56.

Further, the polymer adhesive is prepared from M=20000 organic silicon polymer or M=5000 epoxy resin that will be hardened when heated to 80˜100° C.

Further, the compound material of the present invention is kept in contact of the main radiation surface and periphery of the InGaN heterostructure, forming a 100˜180 μm uniform concentration configuration.

Further, the specific surfaces of the two inorganic elements of the compound material are 6˜12·10³ cm²/cm³ for the inorganic phosphor and 200˜300·10³ cm²/cm³ for the quantum dots. Under this condition, the inorganic phosphor is a garnet powder having a natural individual clear figure, and the quantum dots have a geometric diameter d□30˜40 nm and a sharp angle configuration.

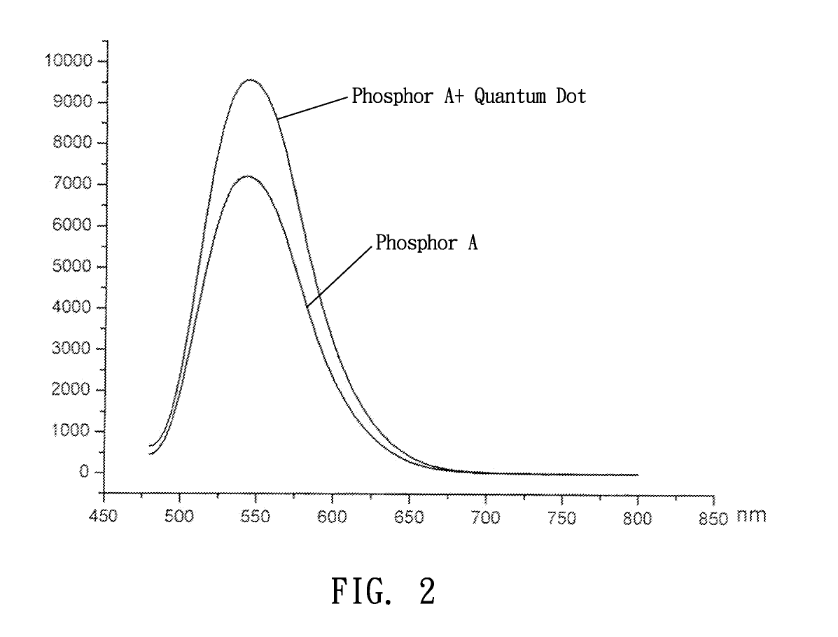

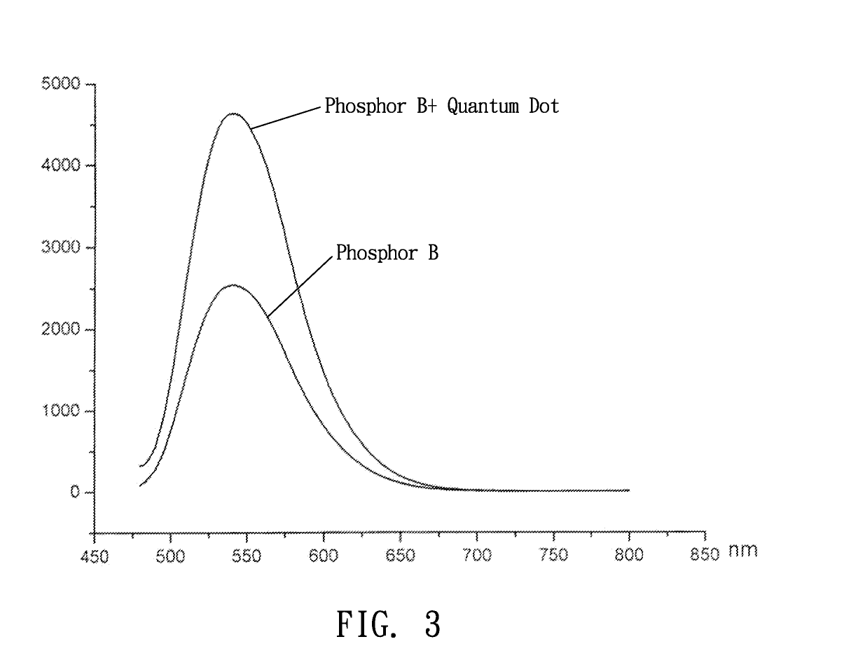

The optical properties of the compound material of the present invention will be described hereinafter. At first, the compound material includes three substances, i.e., two inorganic substrates and one organic substrate. The properties of these substrates are extraordinary. The variation of material optical properties is shown in FIGS. 2 and 3. These two drawings show variation of the inorganic phosphor in luminous intensity and emission spectrum intensity. The two lower spectrum curves in FIGS. 2 and 3 describe the radiation of (Y,Gd,Ce)₃Al₅O₁₂ garnet phosphor. The phosphor A of FIG. 2 has a surface configuration different from the phosphor B of FIG. 3 that is crushed and ground to show an individual clear figure. The two upper spectrum curves in FIGS. 2 and 3 fit the total luminance of the three-component compound material provided according to the present invention that has contained therein two inorganic substances and one organic adhesive.

Hereinafter, we describe the spectrum data shown in FIG. 2. When activated by blue light λ=460 nm, the inorganic phosphor A provides luminance intensity H=7216 units, spectrum curve half-wave width λ_{0.5}=122 nm. Based on this three-component architecture, the radiation maximum value is shifted from original λ=543 nm to λ=544.4 nm, and the luminous intensity is increased to 9569 units or 32%. Further, the Full Wave Half Maximum (FWHM) of the total emission spectrum is increased to λ_{0.5}=124 nm. FIG. 3 shows the inorganic phosphor B activated by blue light λ=460 nm. The initial emission wavelength of the inorganic phosphor B is λ=541.6 nm, and its luminous intensity is H=4635 units. The three-component material produces light at λₘₐₓ=542 nm of luminous intensity H=7485, showing a rise by 62%.

The test results of FIGS. 2 and 3 show a difference that has a great concern with the quantum efficiency of the inorganic phosphors A and B. It is to be understood that the difference between these two phosphors A and B does not exceed by 2˜3% absolute value. When a compound material is made to show a rise in luminous intensity, however the rising degree is not as significant as the phosphor B of FIG. 3.

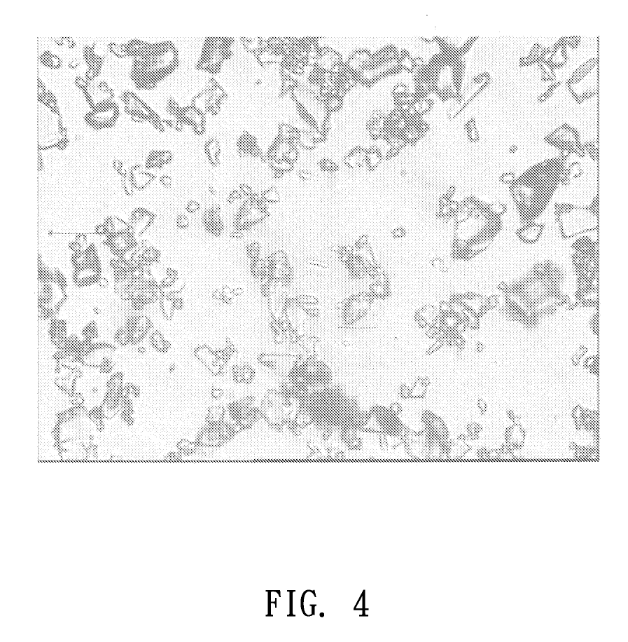

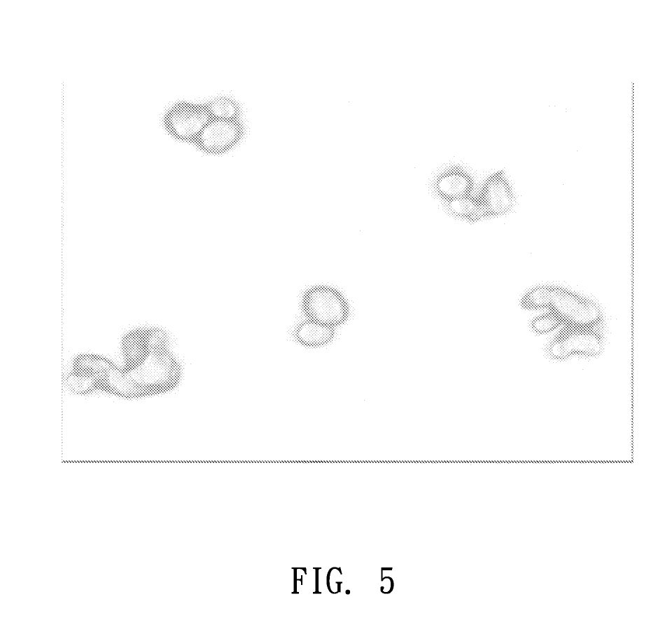

Referring also to FIGS. 4 and 5, the phosphor A has an average particle size d_{cp}□1.8 μm, and maximum diameter d₁₀₀□8 μm (see FIG. 4); the phosphor B has an average particle size d_{cp}□6 μm, maximum diameter d₁₀₀□20 μm, and specific surface S_{yd}=36·10³ cm²/cm³.

It can be said that the load of single-layer of the phosphor is 4 mg/cm². At this time, the difference of the value of the initial luminous intensity is ΔH2−H3=7216−4635=2581 units. At this time, the initial activation of the single-layer of the phosphor B of FIG. 3 produces a loss. This loss has a great concern with penetration of light through gaps in the phosphor powder. The phosphor B of FIG. 3 has a great particle size, thus, subject to first-order approximation, the optical density of the surface of the phosphor B is proportional to its specific surface. Thus, the specific luminous flux value between the phosphor A of FIG. 2 and the phosphor B of FIG. 3 can be recorded as F₂/F₃=62·10³/36·10³=1.72.

When adding 2 mg/cm² CdSe-based quantum dots to the phosphor A, the material will be compacted, causing a rise in refractive index to R=90%. Accordingly, the specific surface of the phosphor A on the surface of the measuring glass is S□80·10³ cm²/cm³ (this value is obtained through a test subject to the use of a reference powder of dispersed Al₂O₃. Thus, when comparing the performance of the phosphor A without quantum dots in reflecting incident light, the performance of the phosphor A with the added quantum dots is increased by Fₒ/F₂=80·10³/62·10³=1.29, i.e., 29%. According to tests, the approximate value of rise in radiation intensity of the compound material is 32%. It is to be understood that the powder layer of the phosphor sample A is fully distributed over CdSe-based quantum dot layer, i.e., the bottom layer is the quantum dot layer and the upper layer is the phosphor A.

Based on tis point of view, we studied the test results of the phosphor B. As stated above, first order radiation from LED exists in gaps in the big-scale powder of the material. When this phosphor is added with standard CdSe quantum dots, a two-layer structure will be formed. The compound material based on the phosphor A with added quantum dots increases the fraction of reflective light to 2353 units. The reflective index of the compound material based on the phosphor B with added quantum dots reaches 250 units, or 21% improvement. From these simple calculation examples, we can obtain some important conclusions: 1. The variation of optical properties of the compound material of phosphor and quantum dots cannot be explained simply based on the simple double-layer reflection model; 2. Any self-assembling action of quantum dots at either layer does not result in a significant growth in reflective index (total 29%), however it increases the mass of the bulky phosphor B that has high optical porosity; 3. the global radiation of the surface layer of the compound material shows characteristics of new physical radiation components that is a combination of the radiation of CdSe-based quantum dots and the radiation of the phosphor and activated by the quantum dots. These important conclusions enable the invention to be created.

It is difficult to estimate the multi-layer radiation of the CdSe-based quantum dots due to of the aforesaid quantum dot self-assembled phenomenon. Subject to measurement through a spectrophotometer from <<Sensing>>, the luminous intensity does not exceed by 10˜15% when compared to the luminous intensity of phosphor. Simply based on the supplementary luminous intensity of the CdSe quantum dots, it cannot be explained that the luminance has substantially increased by 32% and 62%. Therefore, the increased fraction of spectrum conversion according to the examples shown in FIGS. 2 and 3 is a result of the quantum dot-activated phosphor combination radiation. This is an important conclusion obtained from experiments. At this time, the combination radiation fraction in the third architecture of ground phosphor and quantum dots is greatly increased, i.e., the phosphor powder has a clear ground configuration and a large radiation fraction with dispersive d_{cp}=6 μm.

The compound material provided according to the present invention is characterized by the added second inorganic component of A^{II}B^{IV} quantum dot compound, i.e., the light scatter, which is based on CdS—CdSe series, having a Full Wave Half Maximum (FWHM) λ_{0.5}=130˜132 nm and providing radiation at the long wage region λₘₐₓ=542˜544 nm. These data are shown in FIGS. 2 and 3 and have already been discussed.

A positive concept of quantum dot and inorganic phosphor must be explained. A quantum dot is a particle of inorganic substance so small (10˜20 nm) that the addition or removal of an electron charges its properties in some useful way. In a first concept, a quantum dot is discriminated from semiconductor crystal. An independent energy level exists in a quantum dot. At this time, a great energy level is produced in a special energy band (valence band, forbidden band, conduction band) in the semiconductor crystal. Electrons move in three directions in a quantum dot. The emission spectrum of these electrons is similar to the ionic luminous spectrum of independent atoms or gas discharge. From the angle of geometry, a quantum has a size 1×1×1 nm˜10×10×10 nm or greater. At this time, there is only one kind of or some free electrons in the material. They are located in the action region of the residual atoms of the quantum dots.

Hereinafter we are going to discuss the effects of the geometric dimensions of the quantum dots on the physical properties of the material. If one electron exists in an Ag-based quantum dot, thus this quantum dot becomes a dielectric. The spectrum properties of a quantum dot have an important meaning, they have a discontinuous spectral line, similar to the emission spectrum of H or He atom. To some extent, the electron spectrum of a single quantum is similar to the luminescence spectrum of an exciton in a semiconductor, for example, the edge radiation of CdSe crystal is at the orange region of spectrum Eg□1.85 eV, spectral bandwidth Eg=0.01 eV. To explain semiconductor quantum dot, Broil'de wavelength concept must be introduced. It is normally, 60˜100 nm, i.e., when a quantum dot having this wavelength is caused to make a spectrum displacement, it will never be reflected at any location inside the crystal.

In contra to quantum dots, an inorganic phosphor is a synthesized substance having a geometric size 0.5˜100 μm. In this composite, the number of atoms is over 10⁹. Under this condition, an qual number of electrons, i.e., 10⁹ electrons exist in every phosphor particle. To a semiconductor phosphor, such as ZnS.Ag or (Zn—Cd)S.Ag solid solution, their edge exciton radiation is weak, and therefore an activator of special atoms must be added to the whole inorganic phosphor. Unlike quantum dots, a continuous atom combination acts upon an electron combination in the activator. By means of self static field, it balances the discontinuous (quantum) electron properties that are activated by atoms. Due to this reason, the energy bands of all inorganic phosphor spectra are wide bands of which the spectral line width is Eg=0.3˜0.4 eV. Only when the activator of the phosphor exists in the form of rare earth ions and radiation occurs in the internal ion orbit 3 of the activator, quantum forbidden can maintain its influence. The spectral line width of a rare earth phosphor, such as Y₂O₃.Eu is: Eg=0.05˜0.1 eV.

During a use of the inorganic phosphor provided by the present invention, quantum forbidden of the internal orbital radiation is released from the ions due to that Ce⁺³ of (Y,Gd,Ce)₃Al₅O₁₂ obtains radiative electrons in the second d-f orbit, and therefore its radiation is a wide band of spectral line width Eg=0.3˜0.4 eV.

When giving a detailed definition on the quantum dots and the multi-dispersion inorganic phosphor, it can be clearly pointed out that the invention has made some experiments to prove their relative influence. If simply rely upon spectroscopy, GdSe quantum dot narrowband signal will undoubtedly be missed under the great background of the radiation of (Y,Gd,Ce)₃Al₅O₁₂. Therefore, it is more reliable to use spectrophotometer for analysis on optical influences between the inorganic phosphor and the quantum dots.

The invention also made a study on the excitation spectrum of the compound material. It's well known to all that the wavelength of the excitation spectrum of (Y,Gd,Ce)₃Al₅O₁₂ is λ=452˜477 nm, and its global bandwidth is 20˜25 nm. In LEDs of wavelength smaller than 450 nm, Ce⁺³ of inorganic phosphor (Y,Gd,Ce)₃Al₅O₁₂ is not activated to emit light. As indicated by the present invention, the inorganic phosphor and quantum dot compound material starts to emit light when activated by the radiation λ=440 nm of a LED. At this time, when compared with a three-component compound material, the luminous intensity is 75˜85%. The afterglow duration of phosphor (Y,Gd,Ce)₃Al₅O₁₂ is 64 ns. The accurate value of the compound material on this parameter is uncertain, however it does not exceed by τₑ=64 ns.

The advantages of the compound material provided by the present invention is characterized in that the excitation spectrum is shifted toward the shortwave region, including the ultraviolet area of λ=395˜405 nm. When during excitation of shortwave radiation, the afterglow duration is shortened from τₑ=64 ns to a smaller value. It is to be understood that accurate mass ratio among the phosphor, inorganic quantum dots and polymer adhesive of the compound material is important. Further, when the ratio between the phosphor and the quantum dots in the compound material is 10:1, the luminous intensity is enhanced. When the total fraction of the inorganic composition in the organic adhesive reaches 35˜40%, the optimal mass ratio is close to 10:5. When over the quantum dot optimal concentration 45˜55%, an intensity drop on spectrum-light intensity effect is observed. Further, the lower the concentration of the inorganic compositions in the polymer adhesive is, the lower the effective value will be. When the concentration by weight of two inorganic compositions exceeds by 60%, the emission of the compound material becomes unstable. To provide the expected advantages, the compound material is characterized in that the mass ratio of the quantum dot compositions A^{□}B^{□} of the inorganic phosphor in the compound material is 8˜25% and 2˜8%, and the content by weight of the polymer adhesive in the compound material is 66˜90%.

It is for sure that the refractive indexes of the compositions of the compound material shall be within the range of nₚₕ=1.82˜1.90 for the inorganic phosphor, n_{qd}=2.0˜2.4 for the quantum dot material CdS—CdSe, nₚ=1.45˜1.56 for the polymer adhesive. When formed on the surface of an InGaN heterostructure semiconductor, the light output of the compound material will be weakened subject to the influence of the last refractive index nₚ=1.45˜1.56. Till the present time, the refractive index of any polymer composition has this feature. These assure the light output of the compound material reaches 87˜90% of the “external” radiation of the heterostructure surface of the LED. The refractive index ratio of the components of the compound material have the relative relationship of ηₚₕ:η_{qd}:ηₚₒₗ=1.85:2.0:1.55˜1.90:2.4:1.56.

We tested different types of organic adhesives for the compound material, including molecule solvent, polymeric oil of low polymerization degree and thermosetting polymer. In these adhesives, we observed an efficiency improvement. We also observed a relatively higher strength upon the use of epoxy resin on —C—O—Si—O—C— based organic silicon rubber. During a plastic state, the molecular mass of each of these two polymer substrates was over M=5000 carbon units. When heated with a hardening agent to T=80˜100° C., the molecular mass was increased to M=20000 carbon units. It is to be understood that the properties of the hardening agent applied and the applied hardening temperature show no significant influence on spectrum-light intensity effect value.

Having the observed advantages, the compound material is characterized in that the polymer adhesive of the compound material is prepared from an organic silicon polymer of molecular mass M=20000 carbon units or epoxy resin of molecular mass M=5000 carbon units, having a hardened characteristic when heated to 80˜100° C. When used in a LED, the compound material of the present invention forms a polyhedral covering layer on the surface of the LED's heterostructure. A spectrum conversion polymer film based on the compound material of the present invention has a uniform concentration and is kept in optical contact with the radiation surface and periphery of the heterostructure. The optimal concentration of the spectrum conversion polymer film is 100˜180 μm.

The concentration value of the microscopic inorganic phosphor conversion layer illustrated in FIG. 4 is relatively lower. With respect to the phosphor ground powder shown in FIG. 5, the concentration of the conversion layer is preferably relatively higher. When applied to a LED, the spectrum conversion layer based on the compound material of the present invention produces uniform white light of color temperature T=2000˜6000K.

Having the aforesaid advantages, the compound material of the present invention is characterized in that: for use as a spectrum conversion polymer layer, the compound material is kept in optical contact with the domed radiation surface and periphery of the nitride heterostructure, forming a configuration of concentration 100˜180 μm.

The advantages of the compound material prepared according to the present invention are as stated above. Although the spectrum conversion film is not the main subject of the present invention, the aforesaid results are obtained subject to synthesis of the proposed two inorganic compositions. Inorganic phosphor is synthesized through a high temperature heat treatment subject to reaction in weak reductive atmosphere:

(1.5±α)[(2-x-y-z)Y₂O₃+xGd₂O₃+yCeO₂+zDy₂O₃]+(2.5±β)(Al₂O₃)→(Y_{2-x-y-z}GdₓCe_{y}Dy_{z}O₃)_{1.5±α}(Al₂O₃)_{2.5±β}.

The compositions of the compound material are nano-scaled:

Y₂O₃ (purity 99.99%, particle size 0.1 μm)

Gd₂O₃ (purity 99.99%, particle size 0.1 μm)

Dy₂O₃ (purity 9.99%, particle size 0.1 μm)

Al₂O₃ (purity 99.99%, particle size 0.05 μm).

As stated above, the initial inorganic phosphor has a ground configuration of average size d_{cp}□6 μm (see FIG. 5). When the initial phosphor powder is ground by a planet type grinding machine at speed of 1500˜2500 rpm, a part of the powder loses its sharp edges, and the specific surface value is increased to S□60˜62·10³ cm²/cm³.

By means of chromatic dispersion, the degree of dispersion of the CdS—CdSe quantum dots is measured, having a specific surface of 200˜300·10³ cm²/cm³. The quantum dots are synthesized based on CdS—CdSe solid solution. The compound is thiourea and thiourea selenate series. The chemical equation is Cd⁺²+(NH₂)₂C═S⁺(NH₂)₂ C═Se. Using thiourea, thiourea selenate or their mixture can change the concentration of S⁻² or Se⁻² in the solid solution. To obtain a homogeneous precipitate, add citric acid or acetate type ionic complex agent to the original mixture, controlling the reaction temperature within T=40˜80□ and pH□7˜8 units. Because CdO or Cd(OH)₂ fraction concentration in the quantum dot composition is reduced, precipitate prepared within this temperature range has different powder sizes (˜10 nm) and a sharp angle configuration. After synthesis, the prepared product is separated from the solution, and then ground at a speed >10000 rpm for 0.5˜1 hour. The ground powder is rinsed with 0.1% alcohol solution. Thereafter, coated the surface of the quantum dots with a layer of protective coating at a thickness of 1˜3A to avoid quantum dots from particle bonding.

The prepared compound material is characterized in that the compound material includes two inorganic substances, i.e., inorganic phosphor of which the specific surface is 6˜12·10³ cm²/cm³, and the quantum dots of which the specific surface is 200˜300·10³ cm²/cm³; under this condition, the inorganic phosphor has a garnet powder natural individual clear figure, and the quantum dots have a geometric diameter d□30˜40 nm and a sharp angle configuration.

As stated above, the inorganic phosphor of the compound material prepared according to the present invention has a non-stoichiometry yttrium-gadolinium garnet contained therein, which has a cubic lattice configuration and O¹⁰ₕ-Ia3d space composite. The phosphor prepared according to the present invention has the chemical reaction of (Y_{2-x-y-z}GdₓCe_{y}Dy_{z}O₃)_{1.5±α}(Al₂O₃)_{2.5±β}. At this time, the concentration of Gd⁺³ can be 0.01□x□0.4, and the concentration of the activation ions, i.e., cerium ions can be 0.001□y□0.1. The concentration of the second activation ions added, i.e., Dy⁺³ in the phosphor is 0.0001□z□0.01. If the stoichiometry index of the oxide's cation lattice is α□0, thus excessive oxide of Al₂O₃ exists in the phosphor composite, at this time 0.01□β□0.1.

It is for sure, quantum dots formed of (CdS)₁₋ₚ(CdSe)ₚ achieves the maximum efficiency. When 0.01□p□0.8, the three-element compound material substantially improves the luminous intensity of the LED. In an example of LED prepared according to the present invention and having a 200×300 μm heterostructure, when activation power W=0.075, radiation strength was measured to be 1=15 cd, color temperature T=4500K, and flux 51 m, and the light output value of the device was calculated to be η=66 lm/W. To realize these advantages, the compound material of the present invention is characterized in that the inorganic phosphor has a cubic lattice configuration of which the stoichiometry equation is: (Y_{2-x-y-z}GdₓCe_{y}Dy_{z}O₃)_{1.5±α}(Al₂O₃)_{2.5±β},
in which, 0.01□x□0.4
   0.001□y□0.1
   0.00001□z□0.01
   0.01□α□0.1
   0.01□β□0.1
      at this time, the quantum dots are mainly formed of (CdS)₁₋ₚ(CdSe)ₚ solid solution, in which 0.01□p□0.8.

Although a particular embodiment of the invention has been described in detail for purposes of illustration, various modifications and enhancements may be made without departing from the spirit and scope of the invention.

What is claimed is:

1. A compound material for use in a white LED, comprising an inorganic phosphor, an inorganic light scatter and a polymer adhesive for interaction with a shortwave light radiated by an InGaN heterostructure, wherein said light scatter is a nano-scale powder material formed of A^{II}B^{VI} quantum dot compound in which A=Zn, Cd; B═O, S, Se, Te, and composed with (Y_{2-x-y-z} GdₓCe_{y}Dy_{z}O₃)_{1.5±α}(Al₂O₃)_{2.5±β} inorganic phosphor to form a compound material.

2. The compound material as claimed in claim 1, which, in comparison to a standard phosphor, re-radiates the light by a rise about 30˜70%, providing emission spectrum maximum wavelength λ=542˜544 nm, radiation color coordinates 0.32□x□0.36, 0.32□y□0.38, and dominant wavelength λ□548 nm.

3. The compound material as claimed in claim 1, wherein the nano-scale powder material formed of A^{II}B^{VI} quantum dot compound of said light scatter is based on (CdS)_{1˜p}(CdSe)ₚ series, raising Full Wave Half Maximum (FWHM) to λ_{0.5}=130˜132 nm, and simultaneously shifting the radiation toward the long wage region λₘₐₓ=542˜544 nm.

4. The compound material as claimed in claim 1, wherein when the activated spectrum is shifted toward the shortwave region, the shortwave region includes ultraviolet λ=395˜405 nm, and the afterglow duration is shortened from τₑ=64 ns to a relatively smaller value.

5. The compound material as claimed in claim 1, further comprising an inorganic phosphor-A^{II}B^{VI} quantum dot component that has the mass ratio of 8˜25% and 2˜8% when the concentration of said polymer adhesive in the compound material is 66˜90%.

6. The compound material as claimed in claim 1, wherein the refractive index ratio of the components contained therein is: ηₚₕ:η_{qd}:ηₚₒₗ=1.85:2.0:1.55˜1.90:2.4:1.56.

7. The compound material as claimed in claim 1, wherein said polymer adhesive is prepared from M=20000 organic silicon polymer or M=5000 epoxy resin that is hardened when heated to 80˜100° C.

8. The compound material as claimed in claim 1, which is kept in contact of the main radiation surface and periphery of an InGaN heterostructure, forming a 100˜180 μm uniform concentration configuration.

9. The compound material as claimed in claim 1, wherein the specific surfaces of the two inorganic elements of the compound material are 6˜12·10³ cm²/cm³ for the inorganic phosphor and 200˜300·10³ cm²/cm³ for the quantum dots; under this condition, the inorganic phosphor is a garnet powder having a natural individual clear figure, and the quantum dots have a geometric diameter d□30˜40 nm and a sharp angle configuration.
